(19) United States
(12) Patent Application Publication
(10) Pub. No.: US 2013/0106919 A1
(43) Pub. Date: May 2, 2013

(54) PIXEL STRUCTURE AND LIQUID CRYSTAL DISPLAY THEREOF

(71) Applicants: Zui Wang, Guangdong (CN); Chenghung Chen, Guangdong (CN)

(72) Inventors: Zui Wang, Guangdong (CN); Chenghung Chen, Guangdong (CN)

(73) Assignee: SHENZHEN CHINA STAR OPTOELECTRONICS TECHNOLOGY CO., LTD., Guangdong (CN)

(21) Appl. No.: 13/378,268

(22) PCT Filed: Nov. 10, 2011
(86) PCT No.: PCT/CN11/82027

§ 371 Date: Dec. 14, 2011

(30) Foreign Application Priority Data
Nov. 1, 2011 (CN) 201110339179.X

(51) Int. Cl. G09G 3/36; G09G 5/10

(52) U.S. Cl. 345/690; 345/89

(57) ABSTRACT

A pixel structure is disclosed, comprising: a data line; a gate line, located on a first metal layer; a pixel electrode, located on a transparent electrode layer; and an array common line. The array common line extends to form a first shielding metal parallel to the gate line. This invention also relates to a liquid crystal display. The pixel structure of this invention and the accompanying liquid crystal display features the array common line that extends to form a first shielding metal, to settle the drawbacks of low aperture rate and excess side capacitance between the pixel electrode and the gate line of the conventional techniques.

### BACKGROUND OF THE INVENTION

1. Field of the Invention

The present invention relates to liquid crystal display domain. More particularly, the present invention relates to a pixel structure capable of enhancing aperture rate and to a liquid crystal display thereof.

2. Description of the Prior Art

In the conventional pixel structures, a first metal layer is used as the array common line 110 within the active area of a pixel generally, and is designed to parallelize the gate line 120, which means the gate line 120 and the array common line 110 are on the same layer, shown in FIG. 1 and FIG. 2. In FIG. 2, a first metal electrode 130 derived from the array common line 110 is formed to be perpendicular to the array common line 110 and surrounds the pixel electrode 140 of the pixel as a shielding metal.

The drawbacks of the above design lie in that the gate line 120 is in cutoff state most of the time and in negative potential, and therefore forms a bigger potential difference with the color filter common line, where its electric field would affect the orientation of nearby liquid crystal molecules, which causes a light leakage phenomenon along the edge of the pixel, and this calls for a bigger area of black matrix to shield the light leakage region, which consequently reduces the aperture rate of the pixel. Moreover, the shielding metal (the first metal electrode 130) of the pixel electrode 140 isn't placed directly across the gate line 120; however, there is still a side capacitance that exists between the shielding metal and the gate line 120, which boosts the capacitance between the grid electrode and the pixel electrode 140, and the feed through voltage becomes serious that affects the flicker uniformity of the display panel and the property of the image sticking further.

Therefore, it is essential to provide a pixel structure and an accompanying liquid crystal display to settle the existing issues of conventional techniques.

### SUMMARY OF THE INVENTION

The objective of the present invention is to provide a pixel structure with a first metal electrode derived from its array common line and an accompanying liquid crystal display, to settle the reduced aperture rate of a pixel due to the prevention of a light leakage along the edge of the pixel by conventional techniques of the pixel structure and the accompanying liquid crystal display, and the technical problems of the flicker uniformity of the display panel and the property of the image sticking due to an excess side capacitance between a pixel electrode and a gate line.

The present invention relates to a pixel structure, comprising: a data line, used to transmit grayscale signals; a gate line, used to transmit scanning signals, located on a first metal layer; and a pixel electrode, used to drive a pixel based on the grayscale signals, located on a transparent electrode layer, where the pixel structure further comprises: an array common line, used to offer the pixel a common voltage. The array common line extents to form a first shielding metal parallel to the gate line, is located on a second metal layer in between the first metal layer and the transparent electrode layer, and is perpendicular to the gate line. The gate line overlaps with the first shielding metal. The pixel electrode overlaps with the first shielding metal. The array common line further extends to form a second shielding metal along the edge of the pixel electrode, and again extends to form a storage capacitance metal within the pixel electrode region.

The present invention relates to a pixel structure, comprising: a data line, used to transmit grayscale signals; a gate line, used to transmit scanning signals, located at a first metal layer; and a pixel electrode, used to drive a pixel based on the grayscale signals, located at a transparent electrode layer, wherein the pixel structure further comprises: an array common line, used to offer the pixel a common electric potential. The array common line extends to form a first shielding metal parallel to the gate line.

In the pixel structure of the present invention, the array common line is located on a second metal layer that is in between the first metal layer and the transparent electrode layer.

In the pixel structure of the present invention, the array common line is perpendicular to the gate line.

In the pixel structure of the present invention, the gate line overlaps with the first shielding metal.

In the pixel structure of the present invention, the pixel electrode overlaps with the first shielding metal.

In the pixel structure of the present invention, the array common line extends to form a second shielding metal along the edge of the pixel electrode.

In the pixel structure of the present invention, the array common line extends to form a storage capacitance metal within the pixel electrode region.

The present invention further relates to a liquid crystal display, comprising: a scanning driving module, used to generate scanning signals; a data driving module, used to generate grayscale signals; a data line, used to transmit grayscale signals; a gate line, used to transmit scanning signals, located on the first metal layer; and a pixel electrode, used to drive the pixel based on the grayscale signals, located on the transparent electrode layer, wherein the liquid crystal display further comprises: an array common line, used to offer the pixel a common voltage, and the array common line extends to form a first shielding metal parallel to the gate line.

In the liquid crystal display of the present invention, the array common line is located on a second metal layer that is in between the first metal layer and the transparent electrode layer.

In the liquid crystal display of the present invention, the array common line is perpendicular to the gate line.

In the liquid crystal display of the present invention, the gate line overlaps with the first shielding metal.

In the liquid crystal display of the present invention, the pixel electrode overlaps with the first shielding metal.

In the liquid crystal display of the present invention, the array common line extends to form a second shielding metal along the edge of the pixel electrode.

In the liquid crystal display of the present invention, the array common line extends to form a storage capacitance metal within the pixel electrode region.

The pixel structure of the present invention and the accompanying liquid crystal display settles the reduced aperture rate of a pixel due to the prevention of a light leakage along the edge of the pixel by conventional techniques of the pixel structure and the accompanying liquid crystal display, and the technical problems of the flicker uniformity of the display panel and the property of the image sticking due to an excess side capacitance between a pixel electrode and a gate line.

This invention is detailed described with reference to the following preferred embodiments and the accompanying drawings for better comprehension.

### BRIEF DESCRIPTION OF THE DRAWINGS

FIG. 1 is a schematic diagram of the pixel structure of conventional techniques;

FIG. 2 is a cross-sectional diagram of FIG. 1 viewing from A-A;

FIG. 3 is a schematic diagram of the pixel structure of the first embodiment of this invention;

FIG. 4 is a cross-sectional diagram of FIG. 3 viewing from B-B;

FIG. 5 is a schematic diagram of the pixel structure of the second embodiment of this invention;

FIG. 6 is a schematic diagram of the pixel structure of the third embodiment of this invention;

FIG. 7 is a schematic diagram of the liquid crystal display of the first embodiment of this invention;

FIG. 8 is a cross-sectional diagram of FIG. 7 viewing from C-C;

FIG. 9 is a schematic diagram of the liquid crystal display of the second embodiment of this invention; and

FIG. 10 is a schematic diagram of the liquid crystal display of the third embodiment of this invention.

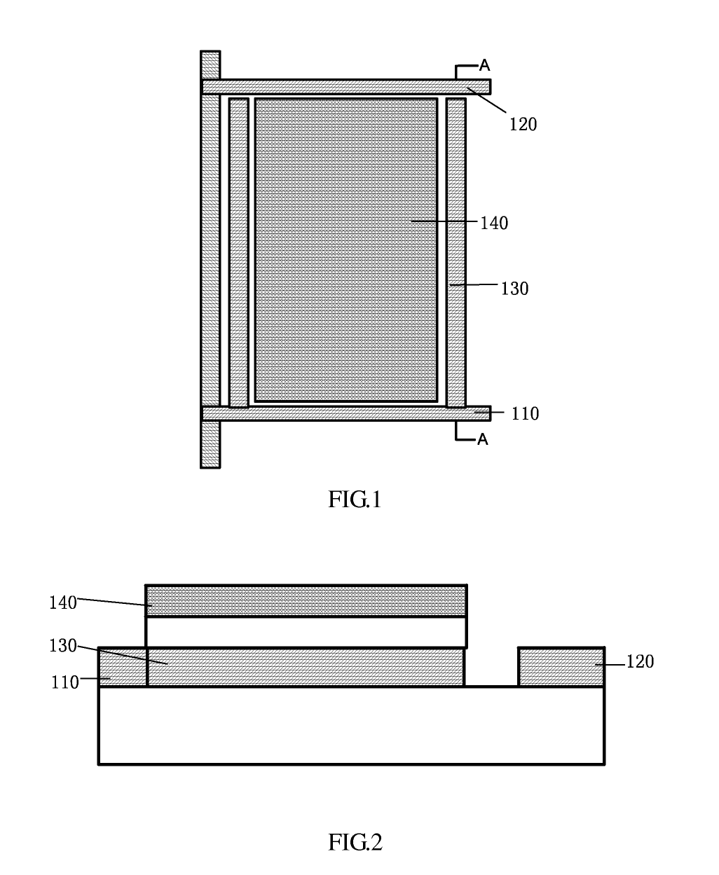

### DETAILED DESCRIPTION OF THE INVENTION

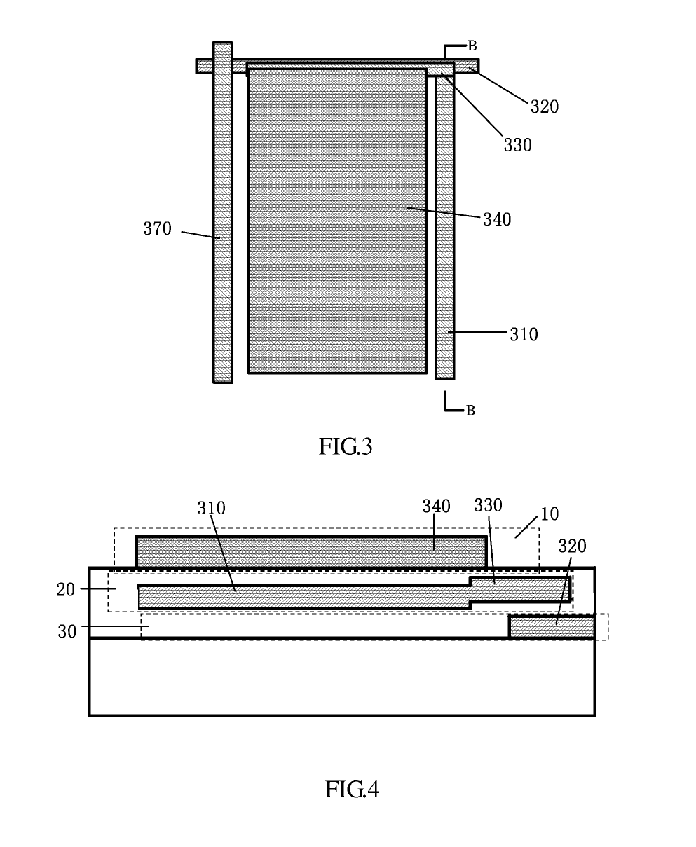

The following embodiments are described with reference to the following accompanying drawings which exemplify the realization of this invention. FIG. 3 is a schematic diagram of the pixel structure of the first embodiment of this invention. The pixel structure comprises a data line 370, a gate line 320, a pixel electrode 340, and an array common line 310. The data line 370 is used to transmit grayscale signals. The gate line 320 is used to transmit scanning signals and is located on a first metal layer 30. The pixel electrode 340 is used to drive the pixel based on the grayscale signals and is located on a transparent electrode layer 10. And the array common line 310 is used to offer the pixel a common voltage. The array common line 310 is located on a second metal layer 20 in between the first metal layer 30 and the transparent electrode layer 10, and is perpendicular to the gate line 320. The array common line 310 extents to form a first shielding metal 330 parallel to the gate line 320.

Referring to FIG. 3, the first shielding metal 330 is extended from the array common line 310. The pixel electrode 340, the first shielding metal 330 and the gate line 320 are located on different layers respectively. Referring to FIG. 4, the pixel electrode 340 is located on the upper transparent electrode layer 10 while the array common line 310 and the first shielding metal 330 are located on the middle second metal layer 20, and the gate line 320 is located on the bottom first metal layer 30. Since the first shielding metal 330 is parallel to the gate line 320, the gate line 320 overlaps with the first shielding metal 330. The edge of the pixel electrode 340 extends upward to overlap with the first shielding metal 330. Meanwhile, the array common line 310 is perpendicular to the gate line 320, which enables the array common line 310 to extend handily to form the first shielding metal 330 parallel to the gate line 320. As the pixel structure of this invention adopts the aforesaid structure, the first shielding metal 330 is acted to shield the light leakage of the pixel electrode 340 at the gate line 320 region, and the pixel electrode 340 is available to lie across the first shielding metal 330, to diminish the coverage of black matrix for enhancing the aperture rate. Moreover, the pixel electrode 340 and the gate line 320 are provided with the first shielding metal 330, to diminish the side capacitance between the pixel electrode 340 and the gate line 320, which reduces the feed-through voltage and improves the flickering uniformity of the display panel and the property of the image sticking.

FIG. 5 is a schematic diagram of the pixel structure of the second embodiment of this invention. In FIG. 5, the array common line 310 extends to form a second shielding metal 350 along the edge of the pixel electrode 340. The second shielding metal 350 can be designed to preferably prevent outside signals to interfere with the pixel electrode 340. The second shielding metal 350 is available to be disposed at the bottom and the left of the pixel electrode 340 shown in FIG. 5, and at the bottom or at the left of the pixel electrode 340 alone subject to the requirements of the users, which achieves partial shielding of the outside signals.

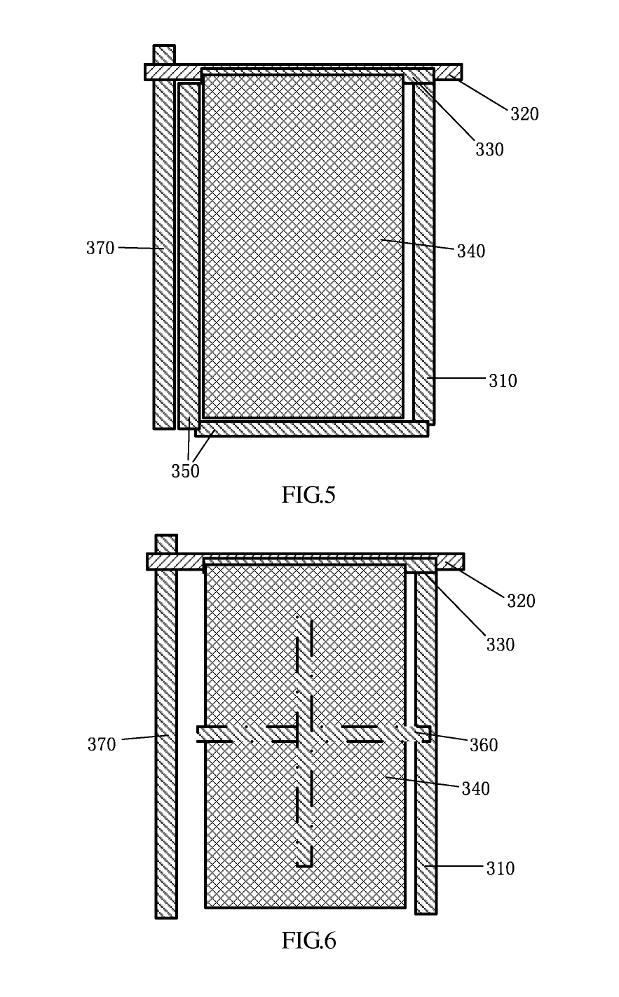

FIG. 6 is a schematic diagram of the pixel structure of the third embodiment of this invention. In FIG. 6, the array common line 310 extends to form a storage capacitance metal 360 within the pixel region. The storage capacitance metal 360 is available to be disposed at the middle of the pixel electrode 340 (shown in FIG. 6), and can be the rim of the pixel electrode 340. The storage capacitance metal 360 can be a single storage capacitance metal 360, or can be two pieces of storage capacitance metal 360 bars perpendicular to each other (shown in FIG. 6). The overlapping portion of the pixel electrode 340 and the storage capacitance metal 360 can be acted as a storage capacitor, and the embodied setup location of the storage capacitance metal 360 is available to alter, subject to the requirements of the user.

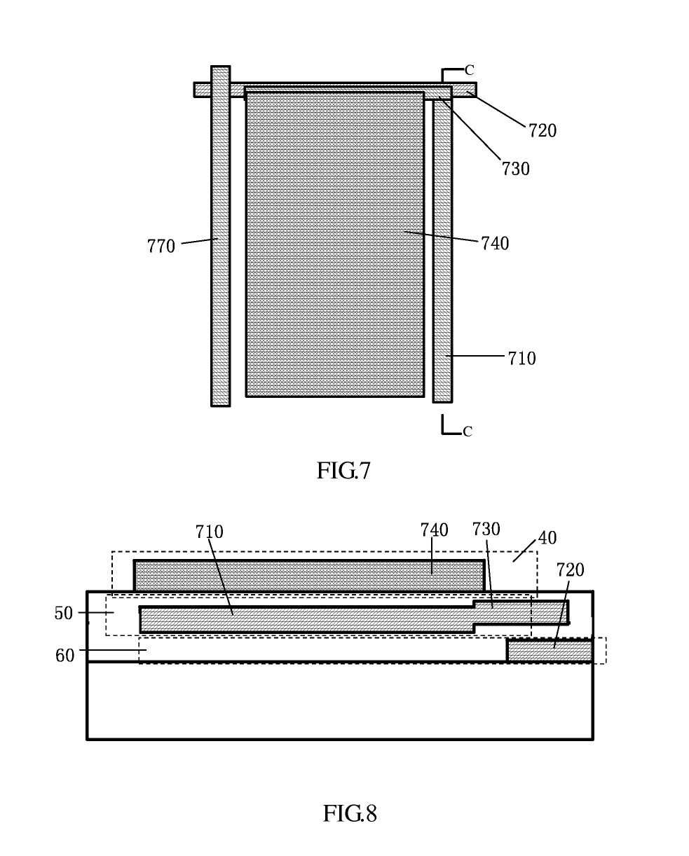

The present invention further relates to a liquid crystal display. FIG. 7 and FIG. 8 show the schematic diagram of the liquid crystal display of the first embodiment of this invention. The liquid crystal display comprises a scanning driving module (not shown in the figure), a data driving module (not shown in the figure), a data line 770, a gate line 720, a pixel electrode 740 and an array common line 710, where the scanning driving module is used to generate scanning signals, the data driving module is used to generate grayscale signals, the data line 770 is used to transmit grayscale signals, the gate line 720 is used to transmit scanning signals and is located at the first metal layer 60, the pixel electrode 740 is used to drive the pixel based on the grayscale signals and is located at the transparent electrode layer 40, and the array common line 710 is used to offer the pixel a common voltage. The array common line 710 is located at a second metal layer 50 in between the first metal layer 60 and the transparent electrode layer 40, is perpendicular to the gate line 720, and extends to form a first shielding metal 730 parallel to the gate line 720.

Referring to FIG. 7, the first shielding metal 730 is extended from the array common line 710. The pixel electrode 740, the first shielding metal 730 and the gate line 720 are located on different layers respectively. Referring to FIG. 7, the pixel electrode 740 is located on the upper transparent electrode layer 40 while the array common line 710 and the first shielding metal 730 are located on the middle second metal layer 50, and the gate line 720 is located on the bottom first metal layer 60. Since the first shielding metal 730 is parallel to the gate line 720, the gate line 720 overlaps with the first shielding metal 730. The edge of the pixel electrode 740 extends upward to overlap with the first shielding metal 730. Meanwhile, the array common line 710 is perpendicular to the gate line 720, which enables the array common line 710 to extend handily to form the first shielding metal 730 parallel to the gate line 720. As the pixel structure of this invention adopts the aforesaid structure, the first shielding metal 730 is acted to shield the light leakage of the pixel electrode 740 at the gate line 720 region, and the pixel electrode 740 is available to lie across the first shielding metal 730, to diminish the coverage of black matrix for enhancing the aperture rate. Moreover, the pixel electrode 740 and the gate line 720 are provided with the first shielding metal 730 in between, to diminish the side capacitance between the pixel electrode 740 and the gate line 720, which reduces the feed-through voltage and improves the flicker uniformity of the display panel and the property of the image sticking.

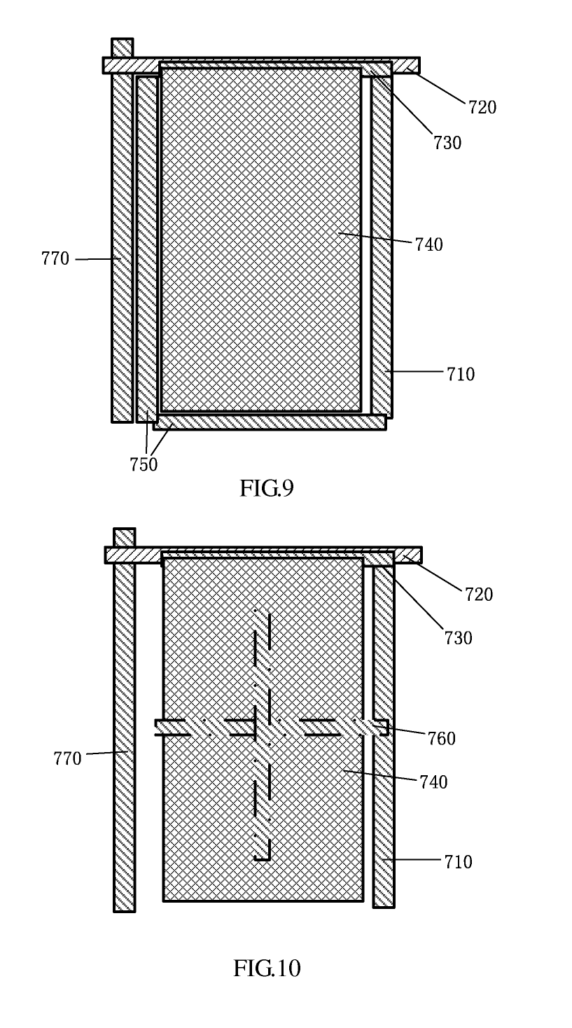

FIG. 9 is a schematic diagram of the liquid crystal display of the second embodiment of this invention. In FIG. 9, the array common line 710 extends to form a second shielding metal 750 along the edge of the pixel electrode 740. The second shielding metal 750 can be designed to preferably prevent outside signals to interfere with the pixel electrode 740. The second shielding metal 750 is available to be disposed on the bottom and the left of the pixel electrode 740 shown in FIG. 9, and at the bottom or the left of the pixel electrode 740 alone, subject to the requirements of the user, which achieves partial shielding of the outside signals.

FIG. 10 is a schematic diagram of the liquid crystal display of the third embodiment of this invention. In FIG. 10, the array common line 710 extends to form a storage capacitance metal 760 within a pixel region. The storage capacitance metal 760 is available to be disposed within the pixel electrode 740 (shown in FIG. 10), and can be the rim of the pixel electrode 740. The storage capacitance metal 760 can be a single storage capacitance metal 760, or can be two pieces of storage capacitance metal 760 bars perpendicular to each other (shown in FIG. 10). The overlapping portion of the pixel electrode 740 and the storage capacitance metal 760 can be acted as a storage capacitor, and the embodied setup location of the storage capacitance metal 760 is available to alter, subject to the requirements of the user.

In conclusion, the preferred embodiments of this invention are disclosed above; however, the aforesaid exemplified embodiments of the present invention are used not for the constraint of the scope; any equivalent modifications, made by those with common knowledge in the field of the present invention, without departing from the spirit and scope of the present invention are therefore intended to be embraced. The present invention is intended to be limited only by the scope of the appended claims.

What is claimed is:

1. A pixel structure, comprising:
a data line, used to transmit grayscale signals;
a gate line, used to transmit scanning signals, located on a first metal layer; and
a pixel electrode, used to drive a pixel based on the grayscale signals, located on a transparent electrode layer;
characterized in that:
the pixel structure further comprises:
an array common line, used to offer the pixel a common electrode voltage, said array common line extending to form a first shielding metal parallel to the gate line;
said array common line being located on a second metal layer in between the first metal layer and the transparent electrode layer;
said array common line being perpendicular to the gate line;
said gate line overlapping with the first shielding metal;
said pixel electrode overlapping with the first shielding metal;
said array common line further extending to form a second shielding metal along the edge of the pixel electrode;
said array common line further extending to form a storage capacitance metal within the pixel electrode region.

2. A pixel structure, comprising:
a data line, used to transmit grayscale signals;
a gate line, used to transmit scanning signals, located on a first metal layer; and
a pixel electrode, used to drive a pixel based on the grayscale signals, located on a transparent electrode layer;
characterized in that:
the pixel structure further comprises:
an array common line, used to offer the pixel a common electrode voltage, said array common line extending to form a first shielding metal parallel to the gate line.

3. The pixel structure as claimed in claim 2, characterized in that: said array common line is located on a second metal layer in between the first metal layer and the transparent electrode layer.

4. The pixel structure as claimed in claim 2, characterized in that: said array common line is perpendicular to the gate line.

5. The pixel structure as claimed in claim 2, characterized in that: said gate line overlaps with the first shielding metal.

6. The pixel structure as claimed in claim 5, characterized in that: said pixel electrode overlaps with the first shielding metal.

7. The pixel structure as claimed in claim 2, characterized in that: said array common line further extends to form a second shielding metal along the edge of said pixel electrode.

8. The pixel structure as claimed in claim 2, characterized in that: said array common line further extends to form a storage capacitance metal within said pixel electrode region.

9. A liquid crystal display, comprising:
a scanning driving module, used to generate scanning signals;
a data driving module, used to generate grayscale signals;
a data line, used to transmit grayscale signals;
a gate line, used to transmit scanning signals, located on a first metal layer; and
a pixel electrode, used to drive a pixel based on the grayscale signals, located on a transparent electrode layer;
characterized in that:
the liquid crystal display further comprises: an array common line, used to offer the pixel a common electrode voltage, and said array common line extending to form a first shielding metal parallel to said gate line.

10. The pixel structure as claimed in claim 9, characterized in that: said array common line is located on a second metal layer in between the first metal layer and the transparent electrode layer.

11. The pixel structure as claimed in claim 9, characterized in that: said array common line is perpendicular to the gate line.

12. The pixel structure as claimed in claim 9, characterized in that: said gate line overlaps with the first shielding metal.

13. The pixel structure as claimed in claim 12, characterized in that: aid pixel electrode overlaps with the first shielding metal.

14. The pixel structure as claimed in claim 9, characterized in that: said array common line further extends to form a second shielding metal along the edge of said pixel electrode.

15. The pixel structure as claimed in claim 9, characterized in that: said array common line further extends to form a storage capacitance metal within said pixel electrode region.
